(19) United States
(12) Patent Application Publication
(10) Pub. No.: US 2026/0246495 A1
(43) Pub. Date: Aug. 20, 2026

(54) PROCESSING OF PLCP HEADER TIMING OF COORDINATED BEAMFORMED PPDU

(71) Applicant: MEDIATEK INC., Hsinchu City (TW)

(72) Inventors: Ray-Kuo Lin, Hsinchu City (TW); Huai-Yan Feng, Hsinchu City (TW); Hung-Tao Hsieh, Hsinchu City (TW)

(73) Assignee: MEDIATEK INC., Hsinchu City (TW)

(21) Appl. No.: 19/055,511

(22) Filed: Feb. 18, 2025

Related U.S. Application Data
(60) Provisional application No. 63/683,255, filed on Aug. 15, 2024.

(51) Int. Cl. H04B 7/022; H04W 48/16; H04W 88/08

(52) U.S. Cl. CPC H04B 7/022; H04W 48/16; H04W 88/08

(57) ABSTRACT

The present invention provides a wireless communication method of a multi-AP system. The multi-AP system includes a first AP and a second AP, and the wireless communication method includes: broadcasting, by the first AP, a coordinated beamforming trigger signal; after the coordinated beamforming trigger signal is broadcasted, transmitting, by the first AP, a first PPDU comprising a first PLCP header and a first payload to a first station; in response to the coordinated beamforming trigger signal, transmitting, by the second AP, a second PPDU comprising a second PLCP header and a second payload to a second station; wherein the first PLCP header and the second PLCP header are non-beamformed PLCP headers, the first payload and the second payload are beamformed payloads, and the first PLCP header and the second PLCP header are not overlapped in time.

### BACKGROUND

The multi-AP coordination techniques have been discussed during Wi-Fi 7 standardization process, and discussion on multi-AP coordination resumed in the working group in charge of defining Wi-Fi 8. In the multi-AP coordination, the interference of multiple transmitting access points (APs) is minimized through the coordinated beamforming technique, wherein the coordinated beamforming technique allows the APs to transmit information to different stations simultaneously. In the current beamforming technique, only the payload of a physical layer protocol data unit (PPDU) is processed by the beamforming mechanism, but a physical layer convergence protocol (PLCP) header of the PPDU is not beamformed. Because the PLCP header is not beamformed, when the coordinated beamforming is used in the multi-AP system, the overlapped non-beamformed PLCP headers of two PPDUs transmitted by two different APs may cause worse demodulation in the corresponding stations.

### SUMMARY

It is therefore one of the objective of the present invention to provide a wireless communication method, wherein two APs transmits the PPDUs to the corresponding stations simultaneously, but the non-beamformed PLCP headers of two PPDUs transmitted by the two APs are not overlapped in time, to solve the above-mentioned problem.

According to one embodiment of the present invention, a wireless communication method of a multi-AP system is disclosed. The multi-AP system comprises a first AP and a second AP, and the wireless communication method comprises: broadcasting, by the first AP, a coordinated beamforming trigger signal; after the coordinated beamforming trigger signal is broadcasted, transmitting, by the first AP, a first PPDU comprising a first PLCP header and a first payload to a first station; in response to the coordinated beamforming trigger signal, transmitting, by the second AP, a second PPDU comprising a second PLCP header and a second payload to a second station; wherein the first PLCP header and the second PLCP header are non-beamformed PLCP headers, the first payload and the second payload are beamformed payloads, and the first PLCP header and the second PLCP header are not overlapped in time.

According to one embodiment of the present invention, a wireless communication method of an AP is disclosed. The wireless communication method comprises the steps of: receiving a coordinated beamforming trigger signal from a first AP, wherein the first AP transmits a first PPDU comprising a first PLCP header and a first payload to a first station after the coordinated beamforming trigger signal; and in response to the coordinated beamforming trigger signal, transmitting a second PPDU comprising a second PLCP header and a second payload to a second station, wherein the first PLCP header and the second PLCP header are non-beamformed PLCP headers, the first payload and the second payload are beamformed payloads, and the first PLCP header and the second PLCP header are not overlapped in time.

According to one embodiment of the present invention, an AP is configured to perform the steps of: receiving a coordinated beamforming trigger signal from a first AP, wherein the first AP transmits a first PPDU comprising a first PLCP header and a first payload to a first station after the coordinated beamforming trigger signal; and in response to the coordinated beamforming trigger signal, transmitting a second PPDU comprising a second PLCP header and a second payload to a second station, wherein the first PLCP header and the second PLCP header are non-beamformed PLCP headers, the first payload and the second payload are beamformed payloads, and the first PLCP header and the second PLCP header are not overlapped in time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-AP system according to one embodiment of the present invention.

FIG. 2 is a timing diagram of two APs transmitting non-beamformed PLCP headers and beamformed payloads according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

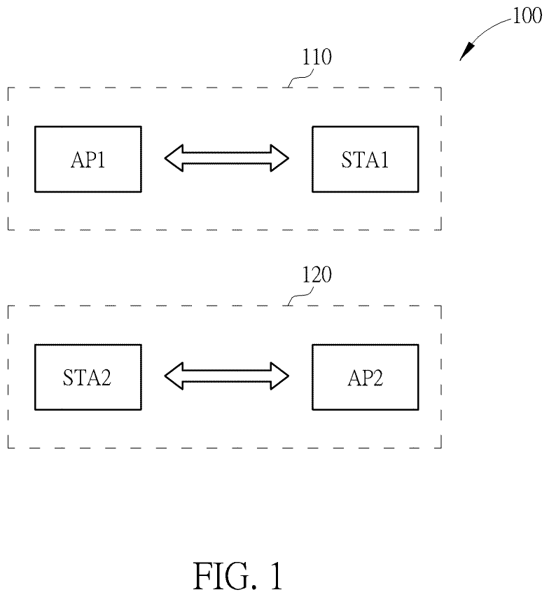

FIG. 1 is a diagram illustrating a multi-AP system 100 according to one embodiment of the present invention. As shown in FIG. 1, the multi-AP system 100 comprises at least two basic service sets (BSS) 110 and 120, wherein the BSS 110 comprises an access point AP1 and a station STA1, and the BSS 120 comprises an access point AP2 and a station STA2. In this embodiment, the access point AP1 is a Wi-Fi access point that allows other wireless devices such as the station STA1 to connect to a wired network, and the access point AP1 mainly comprises a processing circuit and a wireless communication module. The station STA1 is a Wi-Fi station comprising a processing circuit and a wireless communication module, and the station STA1 can be a cell phone, a tablet, a notebook, or any other electronic device capable of wirelessly communicating with the access point AP1. Similarly, the access point AP2 is a Wi-Fi access point that allows other wireless devices such as the station STA2 to connect to a wired network, and the access point AP2 mainly comprises a processing circuit and a wireless communication module. The station STA2 is a Wi-Fi station comprising a processing circuit and a wireless communication module, and the station STA2 can be a cell phone, a tablet, a notebook, or any other electronic device capable of wirelessly communicating with the access point AP2. In addition, each of the wireless communication module mentioned above comprises at least a media address control (MAC) layer circuitry and physical layer circuitry.

In this embodiment, in order to increase the transmission efficiency of the multi-AP system 100, the access points AP1 and AP2 use a coordinated beamforming technique to respectively transmit the PPDUs to the stations STA1 and STA2 simultaneously. As described in the background of the present invention, the overlapped non-beamformed PLCP headers of two PPDUs transmitted by two different APs may cause worse demodulation in the corresponding stations, so the embodiment shown in FIG. 1 proposes a wireless communication method that controls the non-beamformed PLCP headers of two PPDUs transmitted by the access points AP1 and AP2 not overlapped in time, to improve the working efficiency of the stations STA1 and STA2.

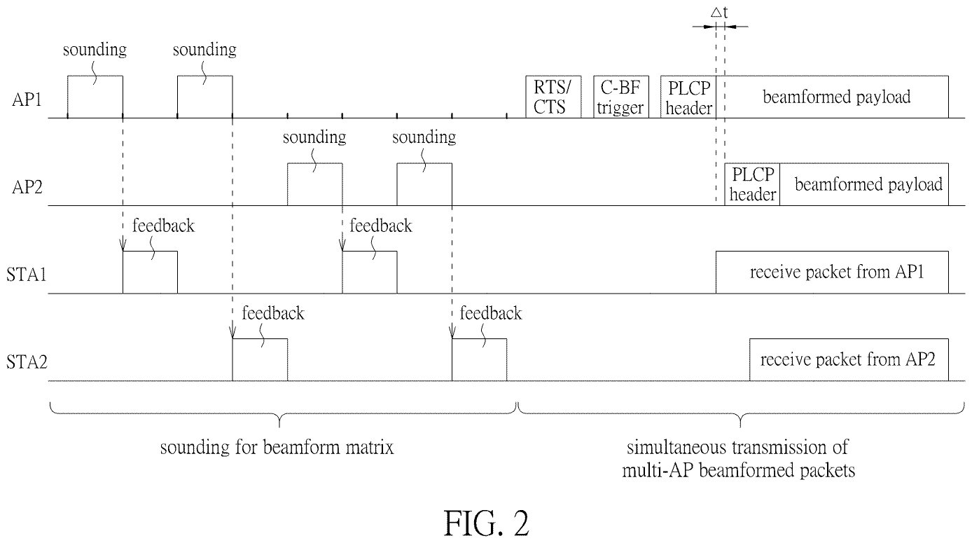

The coordinated beamforming technique performed by the multi-AP system 100 mainly comprises two steps, wherein the first step is sounding for beamform matrix, and the second step is the simultaneous transmission of beamformed packets of the access points AP1 and AP2. Specifically, referring to FIG. 2, in the first step of sounding for beamform matrix, the access point AP1 broadcasts a Null Data Packet Announcement (NDPA) frame to the station STA1, and the station STA1 uses the channel information provided by sounding to calculate a beamforming feedback matrix, wherein the beamforming feedback matrix is transmitted to the access point AP1, for the access point AP1 to use this beamforming feedback matrix to create a steering matrix and beamform transmissions. Then, the access point AP1 broadcasts a NDPA frame to the station STA2 to obtain a beamforming feedback matrix of the station STA2. Similarly, the access point AP2 broadcasts NDPA frames to the stations STA1 and STA2, respectively, to obtain a beamforming feedback matrix of the station STA1 and a beamforming feedback matrix of the station STA2.

Because the first step of sounding for beamform matrix is known by a person skilled in art, and the present invention focuses on the second step of simultaneous transmission of beamformed packets of the access points AP1 and AP2, the detailed description about the sounding procedure is omitted here.

After the sounding procedure, the access point AP1 uses request-to-send (RTS)/clear to send (CTS) control mechanism to reserve the duration for the PPDU transmissions of the access points AP1 and AP2. Then, the access point AP1 broadcasts a coordinated beamforming trigger signal, to inform the access point AP2 to delay the PPDU transmission. Specifically, after a fixed period of time, such as 16 microseconds, after broadcasting the coordinated beamforming trigger signal, the access point AP1 will start transmitting a PPDU. The PPDU comprises a non-beamformed PLCP header and a beamformed payload, wherein the PLCP header comprises four fields: SIGNAL, SERVICE, LENGTH, and CRC as defined in the Wi-Fi specification, and the PLCP header is generated/transmitted without using the beamforming feedback matrix obtained in the sounding procedure, while the payload is generated/transmitted using the beamforming feedback matrix obtained in the sounding procedure.

In addition, after receiving the coordinated beamforming trigger signal from the access point AP2, because the fixed period of time between the end of the coordinated beamforming trigger signal and the time when the access point AP1 starts transmitting the PPDU is known (e.g. 16 microseconds), and the length of the PLCP header is also known, the access point AP2 can know the time when the PLCP header of the PPDU transmitted by the access point AP1 ends. Therefore, after the transmission of the PLCP header of the PPDU transmitted by the access point AP1 ends, the access point AP2 starts to will start transmitting a PPDU (i.e., the time different “Δt” shown in FIG. 2 is greater than zero), wherein the PPDU comprises a non-beamformed PLCP header and a beamformed payload. In one embodiment, the access point AP2 can delay the PPDU transmission with a specific delay time, wherein the specific delay time is determined based on the length of the PLCP header and the fixed period of time between the end of the coordinated beamforming trigger signal and the time when the access point AP1 starts transmitting the PPDU. In this embodiment, the non-beamformed PLCP headers transmitted by the access points AP1 and AP2 are not overlapped, the non-beamformed PLCP header of the PPDU transmitted by the access point AP2 is overlapped with the beamformed payload of the PPDU transmitted by the access point AP1, and most of the beamformed payloads transmitted by the access points AP1 and AP2 are overlapped.

Then, after the station STA1 receives the PPDU transmitted by the access point AP1, the station STA1 sends a block acknowledgement (ACK) to the access point AP1. Similarly, after the station STA2 receives the PPDU transmitted by the access point AP2, the station STA2 sends a block ACK to the access point AP2.

Briefly summarized, in the wireless communication method of the multi-AP system, by intentionally delay the PPDU transmitted by the access point AP2 to make the non-beamformed PLCP header transmitted by the access point AP1 and the PLCP header transmitted by the access point AP2 are not overlapped in time, the stations STA1 and STA2 can have better demodulation quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method of a multi-access point (AP) system, wherein the multi-AP system comprises a first AP and a second AP, and the wireless communication method comprises:
broadcasting, by the first AP, a coordinated beamforming trigger signal;
after the coordinated beamforming trigger signal is broadcasted, transmitting, by the first AP, a first physical layer protocol data unit (PPDU) comprising a first physical layer convergence protocol (PLCP) header and a first payload to a first station;
in response to the coordinated beamforming trigger signal, transmitting, by the second AP, a second PPDU comprising a second PLCP header and a second payload to a second station;
wherein the first PLCP header and the second PLCP header are non-beamformed PLCP headers, the first payload and the second payload are beamformed payloads, and the first PLCP header and the second PLCP header are not overlapped in time.

2. The wireless communication method of claim 1, wherein the step of in response to the coordinated beamforming trigger signal, transmitting, by the second AP, the second PPDU comprising the second PLCP header and the second payload to the second station comprises:
determining a delay time according to a length of the first PLCP header and a fixed period of time between an end of the coordinated beamforming trigger signal and a time when the first AP starts transmitting the first PPDU; and
starting to transmitting the second PPDU to the second station based on the delay time.

3. The wireless communication method of claim 1, wherein the second PLCP header of the second PPDU is overlapped with the first payload of the first PPDU in time, and at least a portion of the second payload of the second PPDU is overlapped with the first payload of the first PPDU.

4. The wireless communication method of claim 1, further comprising:
performing a sounding procedure, by the first AP and the second AP, to obtain beamforming feedback matrixes from the first station and the second station;
wherein the first payload and the second payload are generated/transmitted according to the beamforming feedback matrixes, but the first PLCP header and the second PLCP header are generated/transmitted without any one of the beamforming feedback matrixes.

5. A wireless communication method of an access point (AP), comprising:
receiving a coordinated beamforming trigger signal from a first AP, wherein the first AP transmits a first physical layer protocol data unit (PPDU) comprising a first physical layer convergence protocol (PLCP) header and a first payload to a first station after the coordinated beamforming trigger signal; and
in response to the coordinated beamforming trigger signal, transmitting a second PPDU comprising a second PLCP header and a second payload to a second station, wherein the first PLCP header and the second PLCP header are non-beamformed PLCP headers, the first payload and the second payload are beamformed payloads, and the first PLCP header and the second PLCP header are not overlapped in time.

6. The wireless communication method of claim 5, wherein the step of in response to the coordinated beamforming trigger signal, transmitting the second PPDU comprising the second PLCP header and the second payload to a second station comprises:
determining a delay time according to a length of the first PLCP header and a fixed period of time between an end of the coordinated beamforming trigger signal and a time when the first AP starts transmitting the first PPDU; and
starting to transmitting the second PPDU to the second station based on the delay time.

7. The wireless communication method of claim 5, wherein the second PLCP header of the second PPDU is overlapped with the first payload of the first PPDU in time, and at least a portion of the second payload of the second PPDU is overlapped with the first payload of the first PPDU.

8. The wireless communication method of claim 5, further comprising:
performing a sounding procedure to obtain beamforming feedback matrix from the second station;
wherein the second payload is generated/transmitted according to the beamforming feedback matrix, but the second PLCP header is generated/transmitted without the beamforming feedback matrix.

9. An access point (AP), configured to perform the steps of:
receiving a coordinated beamforming trigger signal from a first AP, wherein the first AP transmits a first physical layer protocol data unit (PPDU) comprising a first physical layer convergence protocol (PLCP) header and a first payload to a first station after the coordinated beamforming trigger signal; and
in response to the coordinated beamforming trigger signal, transmitting a second PPDU comprising a second PLCP header and a second payload to a second station, wherein the first PLCP header and the second PLCP header are non-beamformed PLCP headers, the first payload and the second payload are beamformed payloads, and the first PLCP header and the second PLCP header are not overlapped in time.

10. The AP of claim 9, wherein the step of in response to the coordinated beamforming trigger signal, transmitting the second PPDU comprising the second PLCP header and the second payload to a second station comprises:
determining a delay time according to a length of the first PLCP header and a fixed period of time between an end of the coordinated beamforming trigger signal and a time when the first AP starts transmitting the first PPDU; and
starting to transmitting the second PPDU to the second station based on the delay time.

11. The AP of claim 9, wherein the second PLCP header of the second PPDU is overlapped with the first payload of the first PPDU in time, and at least a portion of the second payload of the second PPDU is overlapped with the first payload of the first PPDU.

12. The AP of claim 9, further comprising:
performing a sounding procedure to obtain beamforming feedback matrix from the second station;
wherein the second payload is generated/transmitted according to the beamforming feedback matrix, but the second PLCP header is generated/transmitted without the beamforming feedback matrix.
